(19) United States
(12) Patent Application Publication
(10) Pub. No.: US 2018/0168135 A1
(43) Pub. Date: Jun. 21, 2018

(54) OPEN EYE HOOK

(71) Applicant: Hency Anthony Bunner, Louisville, KY (US)

(72) Inventor: Hency Anthony Bunner, Louisville, KY (US)

(21) Appl. No.: 15/653,734

(22) Filed: Jul. 19, 2017

Related U.S. Application Data
(60) Provisional application No. 62/498,277, filed on Dec. 20, 2016.

(51) Int. Cl. A01K 83/00

(52) U.S. Cl. CPC A01K 83/00

(57) ABSTRACT

The Open Eye Hook is designed to make fishing faster and easier. The Open Eye Hook is the fishing hook that is designed with the channel gap that allows the fishing line to slip into the eyelet of the hook. The gap compresses the fishing line without any weakening of the strength of fishing line. Once the fishing line is inserted within the eyelet of the hook, the fishing line is locked within the eyelet.

### CROSS-REFERENCE TO RELATED APPLICATIONS

Not Applicable

### STATEMENT REGARDING FEDERAL SPONSORED RESEARCH OR DEVELOPMENT

Not Applicable

THE NAMES OF THE PARTIES TO JOINT RESEARCH AGREEMENT Not Applicable

### INCORPORATION-BY-REFERENCE OF MATERIAL SUBMITTED ON COMPANT DIS OR AS TEXT FILE VIA THE OFFICE ELECTRONIC FILING SYSTEM (EFS-WEB)

Not Applicable

### STATEMENT REGARDING PRIOR DISCLOSURES BY THE INVENTOR OR THE JOINT INVENTOR

Not Applicable

### BACKGROUND OF THE INVENTION

The Open Eye Hook relates to the fishing hook that allows the fishing line to attach to the fishing hook though the eyelet gap in the fishing hook without threading the eyelet or damaging the fishing line.

Prior to this invention, it has been proposed in Japanese Patent Number 2004-283020 to Watanabe, that the face of the shank be shaped into the annular state to prevent from cutting the fishing line when the fish is caught. This patent does not facilitate the attaching of the fishing line to the fishing hook FIG. 1 shows the annular shape (4) (5) (6) as it would appear if the eyelet was pulled back from the shank. This invention does not have the gap for the fishing line to pass through as shown in FIG. 2 where the eyelet end (5) press tight to the shank (2) and thus the fishing line (20) cannot pass in or out of the eyelet. The Open Eye Hook channel gap is designed to lock the fishing line inside the eyelet of the fishing hook without threading the eyelet of the fishing hook.

Japanese Patent Number 2009-268461 to Hamada, Litsey, is the fishing hook with the elongated eyelet extending down the shank. The channel gap created between the elongated eyelet and the shank is wide enough for the fishing line to pass through into the center of the eyelet. The channel gap is also wide enough to allow the fishing line to slip out. To prevent the fishing line from being dislodged from the fishing hook, the fishing line is wrapped tight around the elongated eyelet and shank closing the gap and creating the obstruction that prevents the fish line from slipping out of the fishing hook. The Open Eye Hook does not have the elongated eyelet. The Open Eye Hook is designed with the channel gap that locks the fishing line inside the eyelet without wrapping the fish line around the fishing hook.

Patent Linsey 2,138,702, is the fishing hook with the elongated eyelet extending down the shank. The channel gap created between the elongated eyelet and the shank is wide enough for the fishing line to pass through into the center of the eyelet. The channel gap is also wide enough to allow the fishing line to slip out. To prevent the fishing line from being dislodged from the fishing hook, the fishing line is wrapped tight around the elongated eyelet and shank closing the gap and creating the obstruction that prevents the fish line from slipping out of the fishing hook. The Open Eye Hook does not have the elongated eyelet. The Open Eye Hook is designed with the channel gap that locks the fishing line inside the eyelet without wrapping the fish line around the fishing hook.

Patent Morrow 2004/0181944 is the fishing hook with the elongated eyelet extending down the shank. The channel gap created between the elongated eyelet and the shank is wide enough for the fishing line to pass through in to the center of the eyelet. The channel gap is also wide enough to allow the fishing line to slip out. To prevent the fishing line from being dislodged from the fishing hook, the fishing line is wrapped tight around the elongated eyelet and shank closing the gap and creating the obstruction that prevents the fish line from slipping out of the fishing hook. The Open Eye Hook does not have the elongated eyelet. The Open Eye Hook is designed with the channel gap that locks the fishing line inside the eyelet without wrapping the fish line around the fishing hook.

### BRIEF SUMMARY OF THE INVENTION

The Open Eye Hood is a fishing hook that is constructed with a channel gap that gradually compresses the fishing line when being attached to the fishing honk and will not damage the fishing line integrity. Once the fishing line is pulled inside the eyelet through the channel gap, the fishing line resumes its original shape. The fishing line is locked within the eyelet due to the narrow exit channel gap with the fishing line resuming to its original sharp.

### BRIEF DESCRIPTION OF THE SEVERAL VIEWS OF THE DRAWING(S)

FIG. 1. Is the side view of the construction of the Open Eye Hook showing the hook shank (1) the eyelet (2), the inlet gap (3), the exit gap (4) and the channel gap (6).

FIG. 3. Is the top view of the looped fishing line (6) prior to being pulled into the eyelet (2) through the channel gap (5).

FIG. 4. Is the side view of the fishing line (6) about to enter the inlet gap (3).

FIG. 5. Is the side view of the fishing line (6) being compressed through the outlet gap (4).

FIG. 6. Is the side view of the fishing line (6) in the eyelet (2) after resuming the fishing line's original diameter.

### DETAILED DESCRIPTION OF THE INVENTION

The Open Eye Hook is designed with the gap channel (5) between the fishing eyelet (7) and the fishing hook shank (1). The channel gap (5) is made up with the inlet gap (3) and the exit gap (4). The inlet gap (3) width varies equal to the diameter of the fishing line (6) being used. The exit gap (4) width is 005 cm to 0.03 cm smaller than the diameter of the fishing line (6) being used. The channel gap (5) allows the looped fishing line (6) to be gradually compressed while being pulled through the exit gap (4) without damaging the fishing line (6). Once the fishing line (6) has entered the center of the fishing hook eyelet (2), the fishing line (6) is locked into the eyelet (2) due the narrow exit gap (4) and the fishing line (6) resuming the fishing line's (6) original shape.

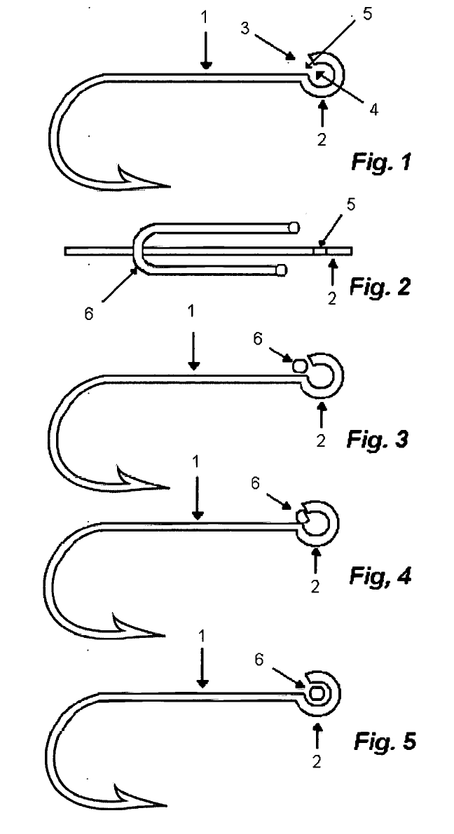

Referring to FIG. 1. Is the side view shown of the fishing hook as having the shank (1), the eyelet (2), the inlet gap (3), the outlet gap 4) and the channel gap (5).

Referring to FIG. 2. Is the top view of fishing line (6) looped prior to being pulled through the eyelet hook channel gap (5). The cross section ends of the fishing line (6) are shown as open.

Referring to FIG. 3. Is the side view of the cross-section of the fishing line (6) is shown outside side the channel gap (5) The Inlet gap (3) width is shown as being the same as the diameter of the fishing line (6).

Referring to FIG. 4. Is the side view cross-section of the fishing line (6) is being compressed as the fishing line (6) is pulled through the exit gap (4). The exit gap is show as being 0.005 cm to 0.02 cm smaller than the diameter of the fishing line (6)

Referring to FIG. 5. Is the side view of the ross-section of the fishing line (6) located inside the eyelet (2). The fishing line (6) shown as resuming the fishing line's (6) original diameter. The fishing line(6) is locked inside the eyelet (2).

### SEQUENCE LISTING

Not Applicable.

1. All fishing hooks have the mechanism for attaching the fishing line to the fishing hook of which the most common mechanism is the eyelet that are manufactured in numerous diameters and strengths; also, the fishing hooks are manufactured in numerous sizes and designs.

2. The Open Eye Hook takes advantage of the difference between hardness of the fishing hook and the compressibility of the fishing line, which the fishing hooks are manufactured from either high-carbon steel, steel alloyed with Vanadium or stainless steel and designed not to bend or compress; whereas, the fishing lines are made of nylon, polyvinylidene fluoride (PVDF, also called fluorocarbon), polyethylene, Dacron and UHMWPE (Honeywell's Spectra or Dyneema); of which the fish line material is resilient and can be compressed without fracture or damage to the strength of the fishing line and can resume it original shape and diameter after being compressed.

3. The Open Eye Hood is the fishing hook that is constructed with the channel gap that gradually compresses the fishing line when being attached to the fishing hook and will not fracture the fishing line strength and once the looped fishing line is pulled inside the eyelet through the channel gap, the fishing line resumes its original shape; the fishing line is locked within the eyelet due to the narrow exit channel gap and fishing line resuming its original shape.
